(19) United States
(12) Patent Application Publication
(10) Pub. No.: US 2005/0277475 A1
(43) Pub. Date: Dec. 15, 2005

(54) Game console in an electronic card game system, an electronic game card to be received thereby, and an electronic card game system

(76) Inventors: Bengt Bern, Molndal (SE); Lars Bern, Goteborg (SE)

Correspondence Address: MANELLI DENISON & SELTER, 2000 M STREET NW SUITE 700, WASHINGTON, DC, 20036-3307, US

(21) Appl. No.: 10/520,111

(22) PCT Filed: Jun. 12, 2003
(86) PCT No.: PCT/SE03/00976

§ 371 Date: Jan. 3, 2005

(30) Foreign Application Priority Data
Jul. 9, 2002 (SE) 0202151-7

(51) Int. Cl. G06F 19/00; G06F 17/00

(52) U.S. Cl. 463/43

(57) ABSTRACT

A game console (1) in an electronic card game system (41) is disclosed. It comprises a power supply (3), a display (5), a processor (7), memory means (9), electronic game card reading means (11), electronic game card writing means (13), electronic game card receiving means (15), and communication means (17) for communicating with at least one other game console. The processor (7) is configured for handling communication with other game consoles, generating a game result, updating electronic game card and displaying information on a display (5) of the game console (1). Also, an electronic game card game system, comprising at least two game consoles (1) and electronic game cards (19, 31) is disclosed.

### TECHNICAL FIELD OF INVENTION

The present invention relates to a game console in an electronic game card game system, an electronic game card able to be at least partially inserted in to the game console, and an electronic game card game system.

### TECHNICAL BACKGROUND

For many years, young people have used cards for entertainment purposes. For instance images, or names, of famous football players, ice hockey players and other well known individuals have been printed on cards. Cards of this type are collected by individuals and traded between individuals of the younger generation. Also, by comparing features of the cards they became a type of game card, which could be won or lost.

The performance of information technology has increased over the last years. Also, the price of information technology has decreased during the last years. This has led to an increased usability of information technology. Today information technology can be found in games for young people.

In WO 01/48580, a computerized trading card system is disclosed. It deals with a system for collecting and using electronic cards. A card is read by a user's computer that is arranged to communicate with a server with a high level of security. A limitation of the invention presented in WO 01/48580 is that in order to be able to play there has to be a connection to the server since the server comprises the computer game software. Also, the need of a local computer and the need of communication arrangement in relation to the server result in a lower feeling of interaction with an opponent, since a user is clearly playing against a server, which is remote. Also, it leads to a lower flexibility in terms of where to play a game.

### SUMMARY OF THE INVENTION

A purpose of the present invention is to alleviate the limitations described above by introducing a game console, an electronic game card and a game system according to the present inventive concept.

According to a first aspect of the present inventive concept, a game console in an electronic card game system is disclosed. It comprises a power supply, a display, a processor, memory means, electronic game card reading means, electronic game card writing means, electronic game card receiving means, and communication means for communicating with at least one other game console. The processor is configured for reading a first data item from an electronic game card which is at least partially inserted in the electronic game card receiving means, using the electronic game card reading means. The electronic game card comprises a memory comprising changeable data, which comprises at least one game related attribute and at least one value associated thereto. The at least one game related attribute can be seen as a dimension in which a game can be played. A value associated to a game related attribute can be seen as magnitude of that dimension. For instance, a game related attribute may consist of strength, beauty, or intelligence. The processor is further configured for receiving a second data item from a second game console using the communication means, where the data comprises at least one game related attribute and at least one value associated thereto. The at least one game related attribute of the second data item and the first data item correspond in order to be able to provide a game result. The processor is further configured for generating a game result based on the first data item and the second data item in respect of the at least one game related attribute and the at least one value associated thereto. The processor is further configured for writing at least one first new value related to the at least one game related attribute to the memory of the electronic game card, using the electronic game card writing means. Thus, this is an updating procedure of the electronic game card. In order to update the other card, the processor is further configured for transmitting at least one second new value data in relation to the at least one other game console using the communication means. Also, the processor is configured for displaying, on the display, at least one of
1. the first data item,
2. the second data item,
3. the at least one first new value related to the at least one game related attribute of the electronic game card,
4. at least one second new value related to the at least one game related attribute related to the second game console, and
5.a game result.

An advantage is that the game console is stand alone in its communication with another game console, i.e. there is no need of having a server keeping scores and usage information or other types of information. Another advantage is that it is possible to play the game without the presence of computer with a communication network facilitating communication capabilities with a server, i.e. it is possible for young people to play a game using the game console for instance outdoors, in shops, and at school. A requisite for a user to be able to play a game with a game console and an electronic game card is that there is at least one opponent also having a game console, arranged for communication with the game console, and an electronic game card.

In a preferred embodiment the power supply is one of a battery and a mains power supply. An advantage of using a battery for power supply is that the flexibility in terms of freedom to choose locations for playing with the game console increases. An advantage of using a mains power supply is that the safe operation of the game console, since there is a risk of batteries running out.

In a preferred embodiment the game result is also based on a random function. This means that it is possible to go beyond mere comparison of values of game related attributes, i.e. just because one player has a card that has a higher number of a specific game related attribute compared to an opponent does not necessarily mean that that player necessarily has to win a game. This offers more excitement to the game.

In a preferred embodiment at least one of the at least one first new value and at least one second new value data is decreased. This means that each game. results in decreases of the at least one first new value and the at least one second new value. This may result in a card being rendered useless in relation to playing with it in a game console.

In a preferred embodiment the communication means is arranged for at least one of wireless communication and wired communication. An advantage of using wireless communication between the at least two game consoles is that it is more convenient. Examples of wireless communication include IR and RF, such as Blue Tooth. However, there may be other available to the man skilled in the art. An advantage of using wired communication is that it is safe and more affordable.

In a preferred embodiment, it is further comprising game control means for allowing a player to select among a plurality of game related attributes and initiate a game. An advantage of having game control means is that it allows the game to be more sophisticated.

In a preferred embodiment, it is further arranged to be one of handheld and stationary. An advantage of the game console being handheld is that the comfort of using it increases. However, an advantage of a stationary game console is that such a console may be used on fixed locations, such as playgrounds, restaurants and cafes and other meeting points.

According to a second aspect of the present inventive concept, in an electronic game card game system that comprises at least a first game console and a second game console and the first game console comprises a power supply, a display, a processor, memory means, electronic game card receiving means, electronic game card reading means, electronic game card writing means, and communication means for communicating with at least one other game console, an electronic game card able to be at least partially inserted into the electronic game card receiving means of the first game console is presented. The electronic game card comprises a memory comprising changeable data. The changeable data comprises at least one game related attribute and at least one value associated thereto. Further, the electronic game card, when at least partially inserted in the electronic game card receiving means, is configured for allowing reading of the at least one value related to the at least one game related attribute, using the electronic game card reading means. Further the electronic game card is configured for receiving at least one new value related to the at least one game related attribute, using the electronic game card writing means.

In a preferred embodiment, the electronic game card is configured for receiving a new value from an electronic card refilling device. This offers the opportunity of an easy way of increasing the at least one value associated to the at least one game related attribute.

According to a third aspect of the present inventive concept, an electronic card game system is disclosed. The system comprises at least two game consoles according to the first aspect and electronic game cards according to the second aspect. It should be pointed out that it lies within the scope of the present invention that it is possible to play with two or more game consoles.

According to a fourth aspect of the present inventive concept, a game console in an electronic card game system is disclosed. It comprises a power supply, a display a processor, memory means, electronic game card reading means, electronic game card writing means, electronic game card receiving means, and communication means for communicating with at least one other game console. The processor is configured for allowing selection of a game based on time and distance between the game console and at least one other game console, where the game includes at least two user roles, of which one user role intended to seek, or chase, the other ones. In a game situation there may be one user seeking one or more other users using game devices. Alternatively, there may be a number of users seeking a single user. In case a player seeking another player succeeds, then that player wins and transferral of points is actuated. In case there are several players seeking a player, then that player who first comes within communication range wins the game. Of course there are options lying in between these two examples. The processor is further configured for receiving an indication of the role of the at least two roles the user will play in the game. The user inputs the role, i.e. either the role. of the user seeking or the role of being chased, or followed, the user intends to play in the subsequent game.

The procesor is further configured for reading a first data item from an electronic game card, which is at least partially inserted in the electronic game card receiving means, using the electronic game card reading means. The electronic game card comprises a memory comprising changeable data, which comprises at least one game related attribute and at least one value associated thereto.

The processor is further configured for generating a game result based on whether a distance between the game console and the at least one other game console lies within a communication distance of the communication means has occurred after a predetermined point in time.

The processor is further configured for writing at least one first new value based on the game result and related to the at least one game related attribute to the memory of the electronic game card, using the electronic game card writing means.

In a preferred embodiment, the processor is further configured for transmitting at least one second new value data based on the game result to the at least one other game console using the communication means.

In a preferred embodiment, the power supply is one of a battery and a mains power supply.

In a preferred embodiment, the communication means is arranged for at least one of wireless communication and wired communication.

In a preferred embodiment, the game console further comprises game control means for allowing a player to select among a plurality of game related attributes and initiate a game.

In a preferred embodiment, the game console is further arranged to be one of handheld and stationary.

### DESCRIPTIONS OF THE DRAWINGS

FIG. 1 schematically illustrates an embodiment of a game console in an electronic card game system.

FIG. 2 schematically illustrates an embodiment of an electronic game card able to be at least partially inserted into the electronic game card receiving means of a game console.

FIG. 3 schematically illustrates an embodiment of an electronic card game system, comprising two game consoles and electronic game cards.

### DESCRIPTION OF PREFERRED EMBODIMENTS

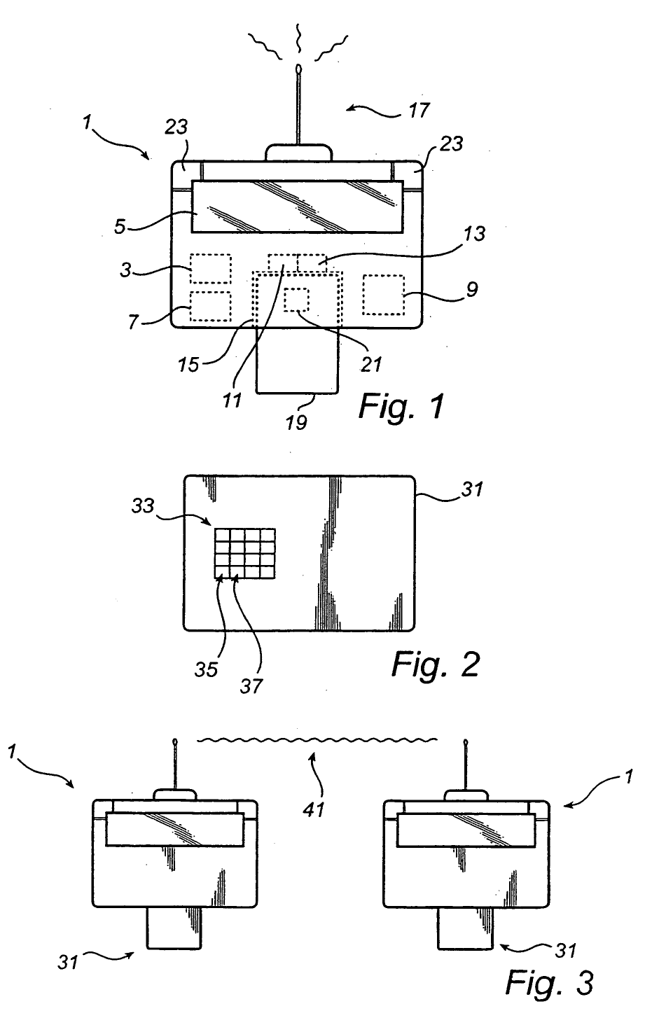

In FIG. 1, a game console 1 in an electronic card game system is disclosed. The game console 1 comprises a power supply 3, a display 5, a processor 7, memory means 9, electronic game card reading means 11, electronic game card writing means 13, electronic game card receiving means 15, and communication means 17 for communicating with at least one other game console. The processor 7 is configured for reading a first data item from an electronic game card 19 at least partially inserted in the electronic game card receiving means 15, using the electronic game card reading means 11. The electronic game card 19 is arranged to comprise a memory 21 comprising changeable data, where the changeable data comprises at least one game related attribute and at least one value associated thereto. The processor 7 is further configured for receiving a second data item from a second game console using the communication means 17, where the data comprising at least one game related attribute and at least one value associated thereto. The processor 7 is further configured for generating a game result based on the first data item and the second data item in respect of the at least one game related attribute and the at least one value associated thereto. The processor 7 is further configured for writing at least one first new value related to the at least one game related attribute to the memory 21 of the electronic game card 19, using the electronic game card writing means 13. The processor 7 is further configured for transmitting at least one second new value data in relation to the at least one other game console using the communication means 17. The processor 7 is further configured for displaying, on the display 5, at least one of: the first data item, the second data item, the at least one first new value related to the at least one game related attribute of the electronic game card, at least one second new value related to the at least one game related attribute related to the second game console, and a game result.

In an embodiment the power supply is a battery.

In another embodiment the power supply is a mains power supply.

In an embodiment the game result is also based on a random function. For instance, the random function can be implemented to introduce a relative likelihood of a game going the unexpected way, e.g. the strongest does not necessarily win a specific game. For instance, assuming that one player has an electronic game card indicating a strength of 23, a second player has an electronic game card indicating a strength of 18, the random function may introduce a 20% offset of the strengths and if the strengths overlap the second player wins, i.e. the first player will have a strength interval of 18.4 to 27.6 and the second player will have a strength interval of 14.4 to 21.6. In this example the first player would lose since the strength intervals overlap. It should be pointed out that there are several alternatives conceivable in relation to the random function and due to the fact that this presentation of alternatives is limited does not limit the scope of the invention.

In an embodiment, at least one of the at least one first new value and at least one second new value data is decreased. For instance, the two strengths indicated above will be decreased in relation to a game by for instance 3 points each. It should be pointed out that the decrease of the strengths not necessarily has to be the same for all players.

In an embodiment the communication means 17 is arranged for at least one of wireless communication and wired communication.

In an embodiment, the game console 1 further comprises game control means 23 for allowing a player to select among a plurality of game related attributes and initiate a game.

In an embodiment, the game console 1 further arranged to be one of handheld and stationary. The game console 1 in FIG. 1 is handheld.

In FIG. 2, an embodiment of an electronic game card 31 is presented. The electronic game card 31 is intended to be used in relation to the game console 1.

In an embodiment of the electronic game card 31, it is able to be at least partially inserted into the electronic game card receiving means 15 of the first game console 1. The electronic game card 31 comprises a memory 33 comprising changeable data. The changeable data comprises at least one game related attribute 35 and at least one value associated thereto 37. The electronic game card 31, when inserted into the electronic game card receiving means 15, is configured for allowing reading of the at least one value 37 related to the at least one game related attribute 35, using the electronic game card reading means 11. The electronic game card 31, when inserted into the electronic game card receiving means 15, is configured for receiving at least one new value 37 related to the at least one game related attribute 35, using the electronic game card writing means 13.

In an embodiment, the electronic game card 31 is configured for receiving a new value from an electronic card refilling device.

In FIG. 3, an electronic game card game system 41 is presented. It comprises two game consoles 1 and electronic game cards 31.

Now turning to exemplifying the operation a game console 1, a possible way handling the game console prior to and during a game session will be presented below.
1. First the electronic game card 31 is inserted into the game console 1.
2. Check one or more game related attributes 35 and their associated values 37, e.g. strength/health status, using the display 5.
3. Check wins/losses in prior games, using the display 5 and game control means 23 to present information loaded in the memory means 9.
4. Set interaction mode to friendly/hostile using the game control means 23.
5. Respond to signals afforded by values associated to game related attributes, such as fatigue or hunger.
6. Interact, using the game control means 23, with other players and other game consoles 1.
   a. Selecting which game related attribute, or which game related attributes, to compete with in relation to others. This is achieved by using the game control means 23 and the display 5.
   b. Initiating the game by pressing a game control key 23, causing the game control 1 to perform the tasks indicated above.

Now turning to another preferred embodiment of the present inventive concept, namely a game console 1 in an electronic card game system 41 comprising a power supply 3, a display 5, a processor 7, memory means 9, electronic game card reading means 11, electronic game card writing means 13, electronic game card receiving means 15, and communication means 17 for communicating with at least one other game console. The processor 7 is configured for allowing selection of a game based on time and distance between the game console 1 and at least one other game console. The game includes at least two user roles, one user role intended to seek, or chase, the other ones. In Table 1, a number of non-limiting examples are given in terms of variations of numbers of players and the allocation of roles among players. Here a player is a user of a game console 1.

TABLE 1

| Number of | Number of players | Number of players |
|---|---|---|
| players | seeking/chasing | being chased |
| 2 | 1 | 1 |
| 3 | 1 | 2 |
| 3 | 2 | 1 |
| 4 | 1 | 3 |
| 5 | 2 | 3 |
| 5 | 4 | 1 |

The processor 7 is further configured for receiving an indication of the role of the at least two roles the user of a game console 1 will play in the game. In one embodiment, the user indicates the role of the user and in another embodiment the role is transmitted from another game console (1).

The processor 7 is further configured for reading a first data item from an electronic game card 19, 31, which is at least partially inserted in the electronic game card receiving means 15, using the electronic game card reading means 11. The electronic game card 19, 31 comprises a memory 33, that comprises changeable data. which comprises at least one game related attribute 35 and at least one value 37 associated thereto.

The processor 7 is further configured for generating a game result based on whether a distance between the game console 1 and the at least one other game console 1 lies within a communication distance of the communication means has occurred after a predetermined point in time.

The processor 7 is further configured for writing at least one first new value based on the game result and related to the at least one game related attribute 35 to the memory 33 of the electronic game card 19, 31, using the electronic game card writing-means 13.

In a preferred embodiment of the game console 1, the processor 7 is further configured for transmitting at least one second new value data to the at least one other game console 1 using the communication means 17.

In a preferred embodiment of this aspect from the player view, a game involving two players may be played as follows.

Assume that there are two players, each carrying a handheld portable game console 1, intending to play. One electronic game card is inserted in each game console. Both players choose a game related attribute using their game consoles 1 and then they activate the game on their respective game console 1. When the game is activated, one of the players is selected to be seeking the other one, i.e. this player has the role of a ‘chaser’, and the other one player is to be found, i.e. this player has the role of a ‘runner’.

When it is decided who is the ‘chaser’ and who is ‘runner’ the value of the game related attribute of the ‘chaser’ is reduced x levels and the value of the game related attribute of the ‘chaser’ is increased x levels. Then the ‘runner’ will have a time period t1 to run away. After time period t1 the ‘chaser’ will have a time period of t2 to catch the ‘runner’. If the ‘chaser’ fails the ‘runner’ will keep the credits. If the ‘chaser’ succeeds he will receive the double amount of credits from the ‘runner’ that the ‘chaser’ transferred to the ‘runner’ prior to the chasing, i.e. 2*x.

For example, assume that we have two players A and B, and game parameters include x=5, t1=15 seconds and t2=45 seconds. They both chose the appropriate game related attribute. They activate the game and A is decided to be ‘chaser’ and B is decided to be ‘runner’. At the same time B will receive 5 credits from A. Then it will be shown on the display of the player A game console 1: “WAIT 15 s”, counting the 15 seconds down. At the same time, the game console 1 for player B will indicate “RUN 60 s”, counting the 60 seconds down. When the 15 seconds have been counted down by the player A game console 1, it will indicate “CHASE 45 s” on the display. That means that player A has 45 seconds to catch player B. Catch here means entering into the active sensing area of the wireless communication area of the player B game console 1. This means that the player A game console 1 physically has to run after player B and be that close to the player B game console, typically 1-5 meters, that the wireless link of the player B game console 1 will sense the presence of the player A game console 1. If player A succeeds he will receive 10 credits from the player B game console (this means player B will loose 5 credits).

1-16. (canceled)

17. A game console in an electronic card game system comprising a power supply, a display, a processor, memory means, electronic game card reading means, electronic game card writing means, electronic game card receiving means, and communication means for communicating with at least one other game console, the processor being configured for
reading a first data item from an electronic game card at least partially inserted in the electronic game card receiving means, using the electronic game card reading means, the electronic game card comprising a memory comprising changeable data, the changeable data comprising at least one game related attribute and at least one value associated thereto;
receiving a second data item from a second game console using the communication means, the data comprising at least one game related attribute and at least one value associated thereto;
generating a game result based on the first data item and the second data item in respect of the at least one game related attribute and the at least one value associated thereto;
writing at least one first new value related to the at least one game related attribute to the memory of the electronic game card, using the electronic game card writing means;
transmitting at least one second new value data in relation to the at least one other game console using the communication means; and
displaying, on the display, at least one of: the first data item, the second data item, the at least one first new value related to the at least one game related attribute of the electronic game card, at least one second new value related to the at least one game related attribute related to the second game console, and a game result.

18. A game console according to claim 17, wherein the power supply is one of a battery and a mains power supply.

19. A game console according to claim 17, wherein the game result is also based on a random function.

20. A game console according to claim 17, wherein at least one of the at least one first new value and at least one second new value data is decreased.

21. A game console according to claim 17, wherein the communication means is arranged for at least one of wireless communication and wired communication.

22. A game console according to claim 17, further comprising game control means for allowing a player to select among a plurality of game related attributes and initiate a game.

23. A game console according to claim 17, further arranged to be one of handheld and stationary.

24. In an electronic game card game system, comprising at least a first game console and a second game console, the first game console comprising a power supply, a display, a processor, memory means, electronic game card receiving means, electronic game card reading means, electronic game card writing means, and communication means for communicating with at least one other game console;
an electronic game card able to be at least partially inserted into the electronic game card receiving means of the first game console, the electronic game card comprising a memory comprising changeable data, the changeable data comprising at least one game related attribute and at least one, value associated thereto; the electronic game card when inserted into the electronic game card receiving means, being configured for
allowing reading of the at least one value related to the at least one game related attribute, using the electronic game card reading means; and
receiving at least one new value, which new value is generated by the processor of the first game console and which is related to the at least one game related attribute, using the electronic game card writing means.

25. An electronic game card according to claim 24, further configured for receiving a new value from an electronic card refilling device.

26. An electronic game card game system according to claim 24, comprising at least two game consoles comprising a power supply, a display, a processor, memory means, electronic game card reading means, electronic game card writing means, electronic game card receiving means, and communication means for communicating with at least one other game console, the processor being configured for reading a first data item from an electronic game card at least partially inserted in the electronic game card receiving means, using the electronic game card reading means, the electronic game card comprising a memory comprising changeable data, the changeable data comprising at least one game related attribute and at least one value associated thereto; receiving a second data item from a second game console using the communication means, the data comprising at least one game related attribute and at least one value associated thereto; generating a game result based on the first data item and the second data item in respect of the at least one game related attribute and the at least one value associated thereto; writing at least one first new value related to the at least one game related attribute to the memory of the electronic game card, using the electronic game card writing means; transmitting at least one second new value data in relation to the at least one other game console using the communication means; and displaying, on the display, at least one of: the first data item, the second data item, the at least one first new value related to the at least one game related attribute of the electronic game card, at least one second new value related to the at least one game related attribute related to the second game console, and a game result; and at least two electronic game cards according to claim 24.

27. A game console in an electronic card game system comprising a power supply, a display, a processor, memory means, electronic game card reading means, electronic game card writing means, electronic game card receiving means, and communication means for communicating with at least one other game console, the processor being configured for
allowing selection of a game based on time and distance between the game console and at least one other game console; the game including at least two user roles, one user role intended to seek the other ones;
receiving an indication of the role of the at least two roles the user will play in the game;
reading a first data item from an electronic game card at least partially inserted in the electronic game card receiving means, using the electronic game card reading means, the electronic game card comprising a memory comprising changeable data, the changeable data comprising at least one game related attribute and at least one value associated thereto;
generating a game result based on whether a distance between the game console and the at least one other game console lies within a communication distance of the communication means has occurred after a predetermined point in time; and
writing at least one first new value based on the game result and related to the at least one game related attribute to the memory of the electronic game card, using the electronic game card writing.

28. A game console according to claim 27, wherein the processor is further configured for transmitting at least one second new value data to the at least one other game console using the communication means.

29. A game console according to claim 27, wherein the power supply is one of a battery and a mains power supply.

30. A game console according to claim 27, wherein the communication means is arranged for at least one of wireless communication and wired communication.

31. A game console according to claim 27, further comprising game control means for allowing a player to select among a plurality of game related attributes and initiate a game.

32. A game console according to claim 27, further arranged to be one of handheld and stationary.
